(19) United States
(12) Patent Application Publication
(10) Pub. No.: US 2009/0100700 A1
(43) Pub. Date: Apr. 23, 2009

(54) Rotary valve

(75) Inventors: Marinus Alphonsus Sauerbreij, Almere (NL); Paul Bernhard Van der Linden, Dordrecht (NL)

Correspondence Address: YOUNG & BASILE, P.C., 3001 WEST BIG BEAVER ROAD, SUITE 624, TROY, MI, 48084, US

(73) Assignee: KADANT JOHNSON, INC.

(21) Appl. No.: 11/977,006

(22) Filed: Oct. 23, 2007

(51) Int. Cl. F26B 11/04; F16K 5/06

(52) U.S. Cl. 34/114; 251/315.1; 432/8

(57) ABSTRACT

A rotary valve for interposition between and fluid communication of a rotary joint and a rotating cylinder, comprising a valve body having a passageway therethrough which terminates at a first end of the valve body connectable to a rotary joint and at a second end of the valve body connectable to a rotating cylinder, and a valve disposed within the passageway. The valve is movable between a first, opened position, wherein a fluid is communicable through the passageway, and a second, closed position, wherein a fluid is not communicable through the passageway.

### CROSS-REFERENCE TO RELATED APPLICATIONS

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### FIELD OF THE INVENTION

The present invention pertains generally to apparatus for drying webs of material, such as, for instance, paper-making apparatus, and more particularly to a rotary valve for interposition between a rotating cylinder and a rotary joint in such apparatus.

### BACKGROUND OF THE INVENTION

In numerous industries, including, for example, printing, papermaking, chemicals, and textiles, it is commonplace to employ hollow rotating cylinders into and out of which is transferred a heat exchange medium such as air, water, steam, oil, etc. In the papermaking industry as a more particular example, steam is transferred to rotating drying cylinders in order to raise the temperature of a paper web as it passes over these cylinders, thereby affecting the drying rate of the paper web. The heat exchange medium is transferred from its external source to the cylinders via mechanical unions known as rotary joints which are directly coupled to the cylinders. Rotary joints are generally characterized by stationary and rotating components so that the rotating cylinders may be interconnected in fluid communication with stationary external components such as pipes supplying the heat exchange medium.

More particularly, and with reference to FIG. 1, a journalled cylinder 100 and a rotary joint 200 of conventional construction are shown. The cylinder 100 has an interior chamber (not depicted) in fluid communication with a passageway 101 defined through at least one of the journal ends 102 thereof. The rotary joint 200 also has at least one passageway 201 defined therethrough. Conventionally, the rotary joint 200 is connectable to the cylinder 100 such that the at least one passageway 201 therethrough is in fluid communication with the passageway 101 of the cylinder. More specifically, the conventional rotary joint 200 is characterized by a threaded stem 202 which is threadingly connected to a correspondingly-dimensioned, threaded bore 103 defined in the journal end 102 of the cylinder 100. The passageway 201 passes through the threaded stem 202, while the threaded bore 103 is defined in the journal end 102 coaxial with the passageway 101. By this arrangement, the passageway 201 of the rotary joint and the passageway 101 of the cylinder are in fluid communication when the rotary joint and cylinder are threadingly connected, all as shown in FIG. 1.

Over time, rotary joints can wear out and so need to be replaced. Conventionally, it is necessary to turn off the flow of the heat exchange medium at a source external of the rotary joint and rotating cylinder in order to perform this replacement. Moreover, it is presently necessary to empty the rotating cylinder of any heat exchange medium in order to avoid the same spilling out.

### SUMMARY OF THE DISCLOSURE

The specification discloses a rotary valve for interposition between and fluid communication of a rotary joint and a rotating cylinder, such as are employed in, for instance, paper-making apparatus. The valve comprises a valve body having a passageway therethrough which terminates at a first end of the valve body connectable to a rotary joint and at a second end of the valve body connectable to a rotating cylinder. A valve disposed within the passageway is movable between a first, opened position, wherein a fluid is communicable through the passageway, and a second, closed position, wherein a fluid is not communicable through the passageway.

According to one feature of the invention, the valve is connected to a rotatable stem extending through the valve body so as to be manually accessible from the exterior of the valve body. Rotatable movement of the stem is operative to selectively move the valve between the first and second positions thereof.

Per one feature of the invention, the valve may be a ball valve. The valve may further be positioned in a sealing valve-seat disposed within the valve body passageway.

According to another aspect of the invention, the valve body may comprise at least first and second portions which are removably connected, and wherein separation of the at least first and second portions of the valve body provides access to the valve.

### BRIEF DESCRIPTION OF THE DRAWINGS

These and other features and advantages of the present invention will become apparent upon reference to the following written description and drawings, in which:

FIG. 1 is a lateral cut-away view of a conventional rotary joint and rotating cylinder;

FIG. 2 is a quartering perspective view of the rotary valve of the present invention;

FIG. 3A is a lateral cut-away view of rotary valve of FIG. 2, the valve being shown in the opened condition thereof;

FIG. 3B is a lateral cut-away view of rotary valve of FIG. 2, the valve being shown in the closed condition thereof;

FIG. 4 is an exploded lateral cut-away view of rotary valve of FIG. 2; and

FIG. 5 is a lateral cut-away view of the rotary valve of the present invention shown interposed between a conventional rotary joint and rotating cylinder.

### WRITTEN DESCRIPTION

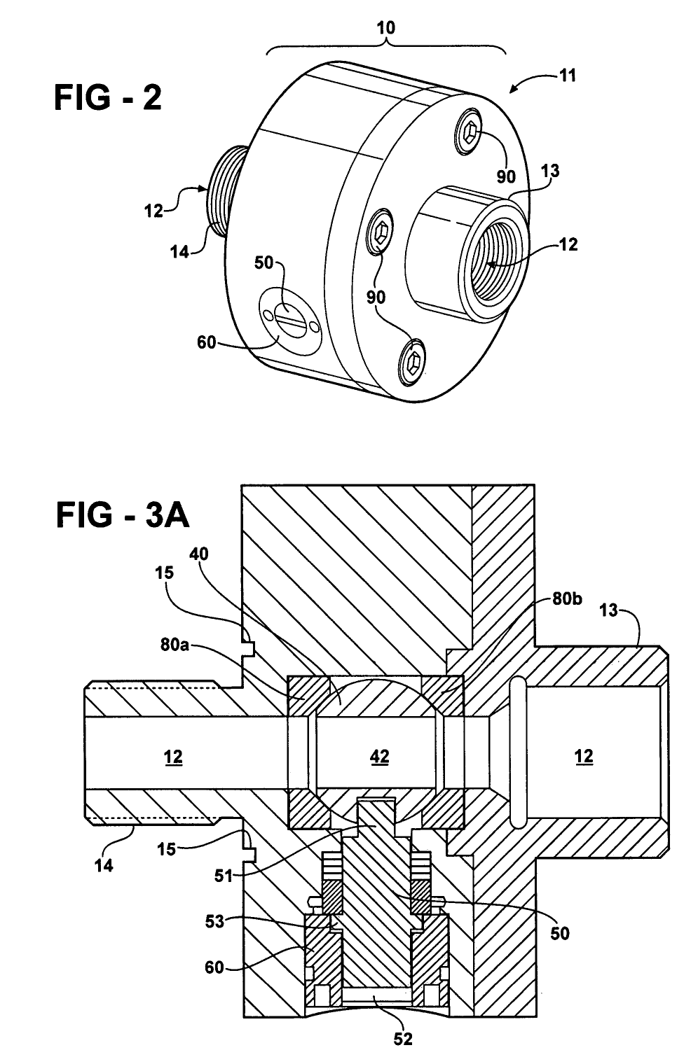

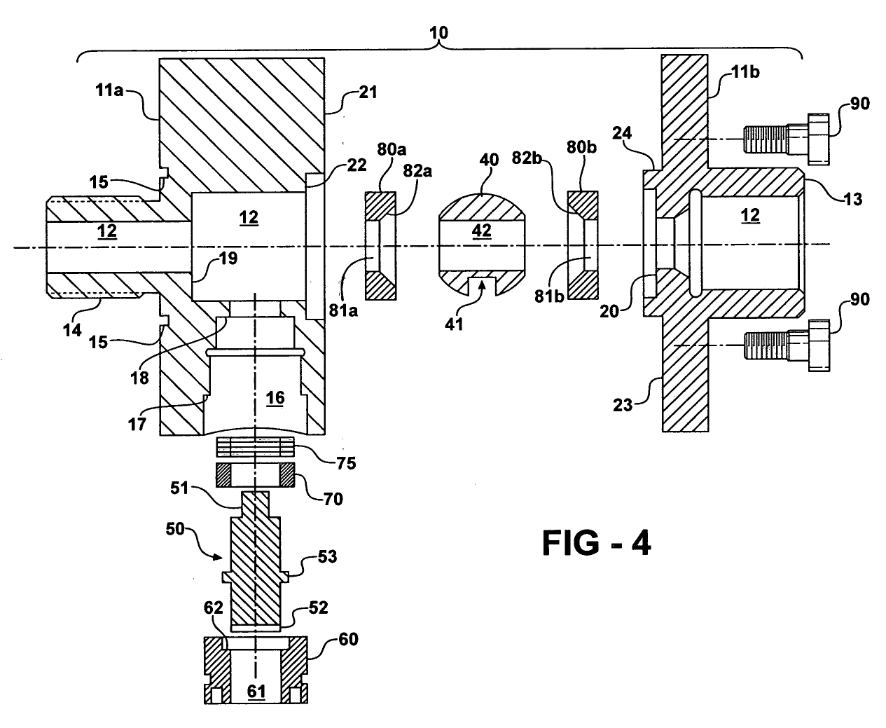

Referring to FIGS. 2 and 4, the rotary valve 10 of the instant invention, which is adapted for interposition between a rotary joint and rotating cylinder, including those of conventional construction such as heretofore described, generally comprises a valve body 11 having a passageway 12 therethrough which terminates at a first end 13 of the valve body which is connectable to a rotary joint and at a second end 14 of the valve body which is connectable to a rotating cylinder, and a valve 40 (not visible in FIG. 2) disposed within the passageway 12 for selectively opening and closing the same.

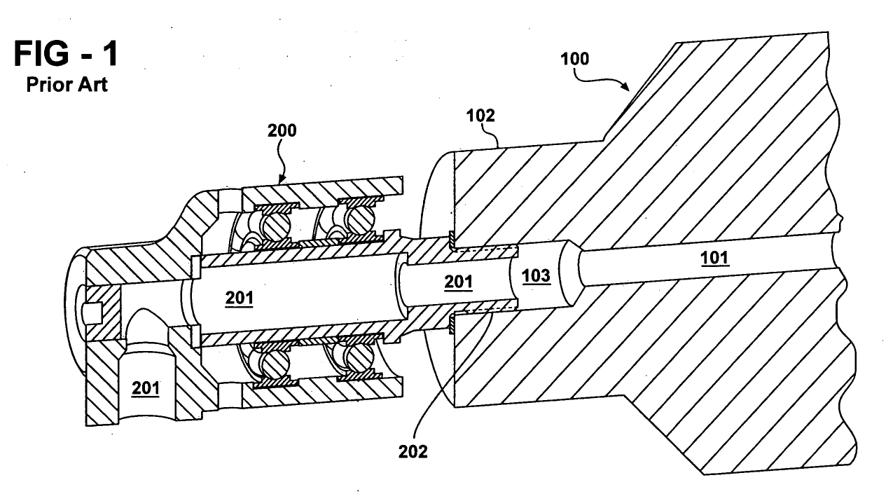

Referring also to FIG. 1—the exemplary valve being adapted to interposition between conventional rotary joints and cylinders which are otherwise directly connected—the valve first end 13 connectable to a rotary joint comprises an internally-threaded stem portion dimensioned to threadingly receive therein the correspondingly externally threaded stem 202 of a rotary joint 200 as described previously. In other words, the first end 13 of the rotary valve of the exemplary embodiment provides an interconnection with the rotary joint 200 comparable to that provided in the conventional cylinder 100.

The valve second end 14 connectable to the cylinder 100 comprises an externally-threaded stem portion dimensioned to be threadingly received in the correspondingly internally threaded bore 103 of the cylinder journal end 102 as heretofore described. In other words, the second end 14 of the rotary valve of the exemplary embodiment provides an interconnection with the cylinder 100 comparable to that provided in the conventional rotary joint 200.

Again, while the foregoing construction facilitates interconnection of the rotary valve of the present invention with rotary joints and cylinders of conventional configuration, such construction is not intended to be limiting. It is contemplated that the rotary valve of the present invention may be modified to permit interconnection thereof with rotary joints and cylinders having constructions other than as described herein.

Still referring to FIGS. 2 and 4, the valve 40 is connected to the first end 51 of a rotatable stem 50 extending through a radial passageway 16 in the valve body 11 so as to be manually accessible from the exterior of the valve body. In the illustrated embodiment, the first end 51 has a non-circular cross-section corresponding to the shape of a bore 41 provided in the valve 40. Of course, the foregoing is not intended to be limiting and other interconnections between the stem 50 and valve 40 are possible, such alternate interconnections being within the ordinary skill in the art.

A second end 52 of the stem 50 accessible to a user through the radial passageway 16 is keyed for a hex wrench, screwdriver, etc. so as to be selectively rotatable thereby.

In the exemplary embodiment, stem 50 includes a radial flange 53 positioned about mid-way along its length. The stem 50 is retained within the radial passageway 16 by a threaded collar 60 which is threadingly secured within a correspondingly-threaded upper portion of the radial passageway 16 terminating in a first annular stop surface 17. The threaded collar includes a central passageway 61 (FIG. 4) having a first diameter along its principal length which corresponds to the diameter of the stem 50 above the flange 53. The central passageway 61 terminates at the lower end thereof in a larger-diameter opening 62 dimensioned to receive the flange 53 therein. Opposite the opening 62, flange 53 abuts nylon and steel packing rings 70, 75, respectively, captured in a narrower-diameter portion of the radial passageway 16 which terminates in a second annular stop surface 18.

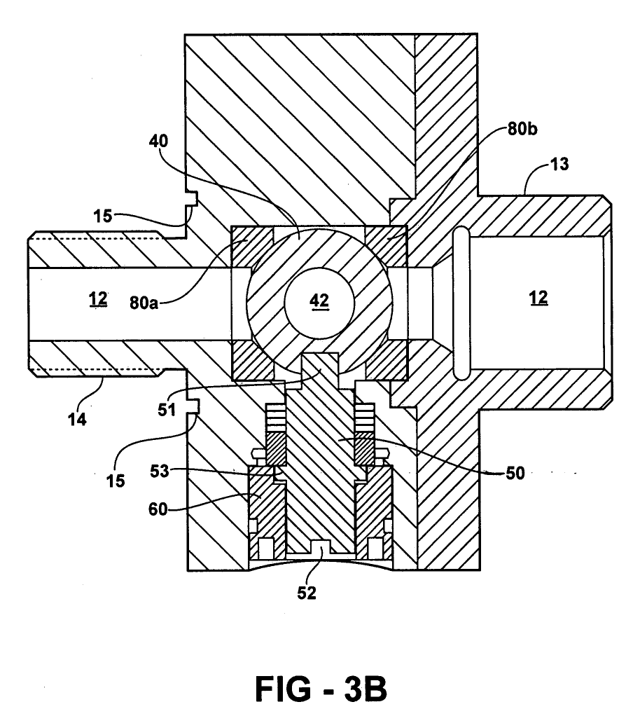

With specific reference to FIGS. 3A through 4, the valve 40 of the exemplary embodiment is a ball valve having a passageway 42 therethrough. By rotating the ball valve through corresponding rotation of the stem 50, the orientation of the passageway 42 is selectively changeable between a first, opened position (FIG. 3A), wherein the longitudinal axis of the passageway 42 is coaxial with the longitudinal axis of the passageway 12 and fluid communication between the rotary joint 200 and rotating cylinder 100 is possible, and a second, closed position (FIG. 3B), wherein the longitudinal axis of the passageway 42 is perpendicular with the longitudinal axis of the passageway 12 and fluid communication between the rotary joint 200 and rotating cylinder 100 is not possible.

The valve 40 is positioned in a sealing valve-seat disposed within the valve body passageway 12, the valve seat comprising first 80a and second 80b seating members each having an opening 81a, 81b therethrough which terminates in a frusto-conical valve seat 82a, 82b. As shown, the passageway 12 transitions to a larger diameter central portion where the valve 40 is positioned, this larger diameter portion defining at opposite ends thereof stop surfaces 19, 20 against which the seating members 80a, 80b are captured.

Of course, other types of valves known to those skilled in the art may be substituted for the foregoing ball valve.

Still referring to FIGS. 3A through 4, the valve body 11 may, and in the exemplary embodiment does, comprise at least first 11a and second 11b portions which are removably connected, such as by bolts 90, wherein separation of these at least first and second portions provides access to the valve 40, as well as the first 80a and second 80b seating members. In the exemplary embodiment, first 11a and second 11b portions are axially mateable, with each defining a portion of the passageway 12, and with the mateable interconnection between the two portions being defined at the location along the passageway 12 where the valve 40 is positioned. Still more specifically, the second portion 11b will be seen to include an inwardly facing mating surface 23 from which extends a mating projection 24 having defined interiorly thereof a portion of the passageway 12 and the stop surface 20 for seating member 80b. The first portion 11a of the valve body includes an opposing, outwardly facing mating surface 21. The passageway 12 opens onto this mating surface 21 via a larger diameter portion defining an annular seat 22 for receiving the mating projection 24.

Of course, it is contemplated that the valve body, if comprised of multiple portions, may be constructed so as to fit together other than as hereinabove described.

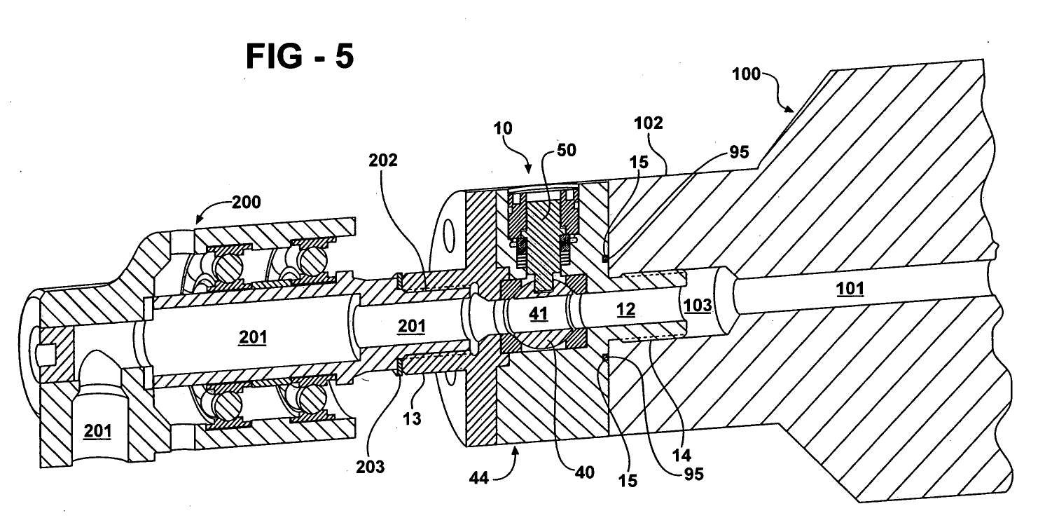

In use, as shown in FIG. 5, the valve 10 is interposed between the normally directly-connected cylinder 100 and rotary joint 200 so that the passageways 101, 201 through the cylinder 100 and rotary joint 200, respectively, can communicate via the passageway 12 through the valve body. More specifically, the threaded stem 202 of rotary joint 200 is threadingly secured in the threaded socket defined by the valve first end 13, while the threaded stem defined by the valve second end 14 is threadingly secured in the threaded socket 103 defined in the journal end of the cylinder 100.

In order to seal the valve 10 against each of the cylinder 100 and rotary joint 200, conventional sealing means may be provided. In the illustrated embodiment, such sealing means as between the valve 10 and rotary joint 200 may take the form of a copper washer 203 positioned between the valve first end 13 and the stem 202 as shown (FIG. 5) or, alternatively may take the form of an O-ring, a gasketed flange connection, tapered threads at the threaded connection between the valve 10 and rotary joint 200, or other conventional means know to those skilled in the art.

In order to seal the valve 10 against the cylinder 100, the sealing means may take the form of an O-ring 95 positioned between the valve 10 and the cylinder's journalled end 102 as shown (FIG. 5). More particularly, the valve 10 is provided with a recessed, annular groove 15 concentric with the stem of the valve second end 14 and oriented in opposition to the end surface of the cylinder journal 102. Within this groove 15 the O-ring 95 is positioned, the O-ring being of sufficient dimensions so as to be compressed between the opposing surfaces of the valve 10 and cylinder journal end 102 when the two are connected. Alternatively, the sealing means may take the form of a copper washer interposed between the valve 10 and cylinder 100, a gasketed flange connection, tapered threads at the threading connection between the valve 10 and cylinder 100, or other conventional means know to those skilled in the art.

It will be appreciated from the above disclosure that the present invention improves upon the prior art by providing a rotary valve of robust yet simple design which is interposable between a rotating cylinder and rotary joint in order to provide a greatly simplified means to quickly replace worn out rotary joints while minimizing production downtime.

Of course, the foregoing is merely illustrative of the present invention, and those of ordinary skill in the art will appreciate that many additions and modifications to the present invention, as set out in this disclosure, are possible without departing from the spirit and broader aspects of this invention as defined in the appended claims.

The invention in which an exclusive property or privilege is claimed is defined as follows:

1. A rotary valve for interposition between a rotating cylinder and a rotary joint, wherein the cylinder has an interior chamber in fluid communication with a passageway through at least one end thereof, and the rotary joint defines at least one passageway therethrough, the rotary joint being connectable to the cylinder such that the at least one passageway therethrough is in fluid communication with the passageway of the cylinder, the rotary valve comprising:
a valve body having a passageway therethrough which terminates at a first end of the valve body which is connectable to the rotary joint and at a second end of the valve body which is connectable to the cylinder such that, when the valve body is interposedly connected to the rotary joint and cylinder, the passageways through the rotary joint and cylinder are in fluid communication via the valve body passageway; and
a valve disposed within the valve body passageway, the valve being movable between a first position, wherein valve body passageway is opened, and a second position, wherein valve body passageway is closed.

2. The valve of claim 1, wherein the valve is connected to a rotatable stem extending through the valve body so as to be manually accessible from the exterior of the valve body, and wherein rotatable movement of the stem is operative to selectively move the valve between the first and second positions thereof.

3. The rotary valve of claim 2, wherein the valve is a ball valve.

4. The rotary valve of claim 3, wherein the ball valve is positioned in a sealing valve-seat disposed within the valve body passageway.

5. The rotary valve of claim 1, wherein the valve body comprises at least first and second portions which are removably connected, and wherein further separation of the at least first and second portions of the valve body provides access to the valve.

6. In an apparatus of the type comprising a rotating cylinder having an interior chamber in fluid communication with a passageway through at least one end thereof, and a rotary joint defining at least one passageway therethrough, the rotary joint being connected to the cylinder such that the at least one passageway therethrough is in communication with the passageway of the cylinder, the improvement comprising:
a rotary valve interposed between the rotating cylinder and rotary joint, the rotary valve comprising a valve body having a passageway therethrough which terminates at a first end of the valve body connected to the rotary joint and at a second end of the valve body connected to the cylinder, the valve body passageway communicating with the passageways through the rotary joint and cylinder, and a valve disposed within the valve body passageway, the valve being movable between a first position, wherein the valve body passageway is opened, and a second position, wherein the valve body passageway is closed.

7. The apparatus of claim 6, wherein the valve is connected to a rotatable stem extending through the valve body so as to be manually accessible from the exterior of the valve body, and wherein rotatable movement of the stem is operative to selectively move the valve between the first and second positions thereof.

8. The apparatus of claim 7, wherein the valve is a ball valve.

9. The apparatus of claim 8, wherein the ball valve is positioned in a sealing valve-seat disposed within the valve body passageway.

10. The apparatus claim 6, wherein the valve body comprises at least first and second portions which are removably connected, and wherein separation of the at least first and second portions of the valve body provides access to the valve.

11. A rotary valve for interposition between and fluid communication of a rotary joint and a rotating cylinder, the valve comprising:
a valve body having a passageway therethrough which terminates at a first end of the valve body connectable to a rotary joint and at a second end of the valve body connectable to a rotating cylinder; and
a valve disposed within the passageway, the valve being movable between a first, opened position, wherein a fluid is communicable through the passageway, and a second, closed position, wherein a fluid is not communicable through the passageway.

12. The rotary valve of claim 11, wherein the valve is connected to a rotatable stem extending through the valve body so as to be manually accessible from the exterior of the valve body, and wherein rotatable movement of the stem is operative to selectively move the valve between the first and second positions thereof.

13. The rotary valve of claim 12, wherein the valve is a ball valve.

14. The rotary valve of claim 13, wherein the ball valve is positioned in a sealing valve-seat disposed within the valve body passageway.

15. The rotary valve of claim 11, wherein the valve body comprises at least first and second portions which are removably connected, and wherein separation of the at least first and second portions of the valve body provides access to the valve.
